(19) United States
(12) Patent Application Publication
(10) Pub. No.: US 2018/0066719 A1
(43) Pub. Date: Mar. 8, 2018

(54) CLUTCH MONITORING

(71) Applicant: Ford Global Technologies, LLC, Dearborn, MI (US)

(72) Inventor: Jacob KLASER, Royal Oak, MI (US)

(21) Appl. No.: 15/259,405

(22) Filed: Sep. 8, 2016

(51) Int. Cl. F16D 48/10; F16D 41/12

(52) U.S. Cl. CPC F16D 48/10; F16D 2121/18; F16D 41/12

(57) ABSTRACT

A controllable one-way clutch has a first annular ring with a central axis of rotation and an outer periphery with at least one tooth. A second annular ring is arranged concentrically with the first annular ring and has a second periphery. A pivotal member is connected to the second annular ring and may be pivoted to an engaged position, when the pivotal member is engaged with the tooth of the first annular ring, from a disengaged position. The pivotal member is in the disengaged position when it is not engaged with the tooth. A sensor fixed to either the first or second annular ring detects the presence of the tooth as the first annular ring rotates. A controller is programmed to prevent the pivotal member from engaging the first ring in response to the sensor indicating the rotational speed of the first annular ring exceeds a threshold.

### TECHNICAL FIELD

The present disclosure relates to controlling the engagement of one-way clutches attached to a transmission of a vehicle to prevent locking the one-way clutch at a high rate of speed.

### BACKGROUND

According to one embodiment, a one-way clutch generally includes an inner race coupled to a first rotatable component and an outer race coupled to a second rotatable component. The one-way clutch engages to transfer torque between the inner race and outer race when the relative rotation between the first and second components is in one direction, and disengages to free wheel when the relative rotation is in a second direction. The one-way clutch is engaged to transfer torque via a pivotable strut that is moved from a disengaged position, when the strut is not in contact with the inner race, to an engaged position, when the strut is in contact with the inner race.

One-way clutches for vehicles can operate up to speeds exceeding 7,500 revolutions-per-minutes. When a strut within a one-way clutch is actuated to engage the inner race at high speeds the one-way clutch can experience issues. As one example, an electrical short could allow current to flow to an actuator causing the strut to be displaced at an inappropriate speed. In another example, an operator could send a signal, incorrectly, to engage the inner race at an incorrect speed.

### SUMMARY

According to one aspect of this disclosure, a controllable one-way clutch has a first annular ring with a central axis of rotation and an outer periphery with at least one tooth. A second annular ring is arranged concentrically with the first annular ring and has a second periphery. A pivotal member is connected to the second annular ring and may be pivoted to an engaged position. When the pivotal member is in the engaged position, it is engaged with the tooth of the first annular ring. When the pivotal member is in a disengaged position, the pivotal member is not engaged with the tooth. A sensor fixed to the second annular ring detects the presence of the tooth as the first annular ring rotates. A controller is programmed to prevent the pivotal member from engaging the first ring in response to the sensor indicating that the rotational speed of the first annular ring exceeds a threshold.

According to a variant of the first embodiment, the assembly additionally includes an electromechanical actuator that has a movable member that applies a force to the pivotable member to displace the pivotable member from the disengaged position to the engaged position. The controller is programmed to prevent the application of force by the electromechanical actuator when the rotational speed of the first annular ring exceeds a threshold. This rotational speed is determined by a sensor that detects the presence and movement of the tooth over time.

According to one embodiment, the rotational-speed threshold of the first annular ring is approximately 100 revolutions-per-minute. As an example, if the first annular ring is rotating below 100 revolutions-per-minute, the controller would allow the pivotable member to engage the first annular ring.

According to another embodiment, the second annular ring has a raised section that forms a pocket that is substantially perpendicular to the central axis of rotation of the first and second annular rings. Additionally, an electromechanical actuator may be disposed within the pocket of the second annular ring.

According to one embodiment, a proximity sensor is disposed within the pocket and is adjacent to the first annular ring.

A method of controlling a one-way clutch according to the present disclosure includes rotating a first race within a second race while detecting a position of the tooth on the first race over time to indicate the speed of the first race. After determining the speed and receiving an engagement command, the controller will prevent locking of the first race and the second race if the speed of the first race exceeds a predetermined threshold. To prevent locking, the controller may prevent the strut from moving from a disengaged position to an engaged position.

One of the ways the controller may prevent the strap from moving from a disengaged position to an engaged position is by inhibiting the electromechanical actuator from receiving electrical current in response to the rotational speed of the first inner ring exceeding the threshold.

According to another aspect of this disclosure, a controllable one-way clutch has a first race and a second race. The first race has a periphery with a tooth. The first and second races are concentrically aligned with each other. A strut is positioned between the first and second race in his pivotable between a disengaged position and engaged position. In the disengaged position the strut is not engaged with the tooth of the first race. And in the engaged position, the strut is engaged with the tooth of the first race. A proximity sensor is configured to output a signal indicating the speed of the first race to a controller to prevent engagement of the strut with the first race when the first race rotates above a predetermined speed. The proximity sensor and controller work in conjunction to define the speed of the first race by detecting the proximity of the tooth.

### BRIEF DESCRIPTION OF THE DRAWINGS

FIG. 1 is a left/front perspective view of a one-way clutch with a strut in the engaged position.

FIG. 2 is a detailed view of a one-way clutch according to the present disclosure.

FIG. 3 is a flowchart of the method of controlling a one-way clutch according to the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

In the following discussion of the figures, a polar coordinate system is utilized. An axial direction extends along an axis of rotation of the clutch. A radial direction extends orthogonal to the axial direction from the axis of rotation toward a periphery of the clutch. A circumferential direction extends orthogonal to the radial direction within the general plane of the clutch.

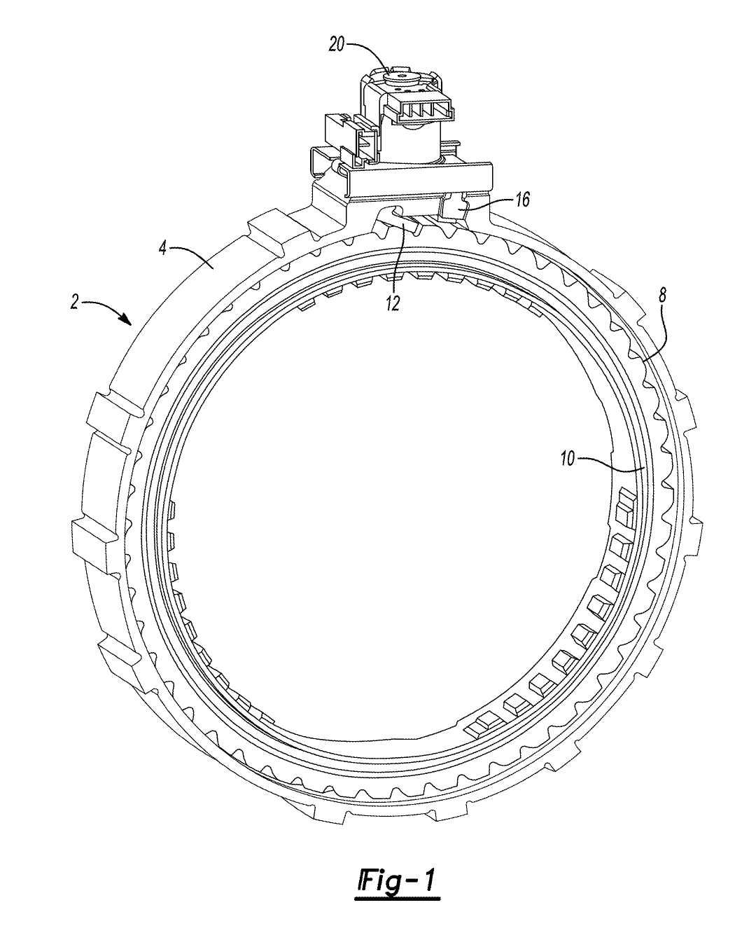

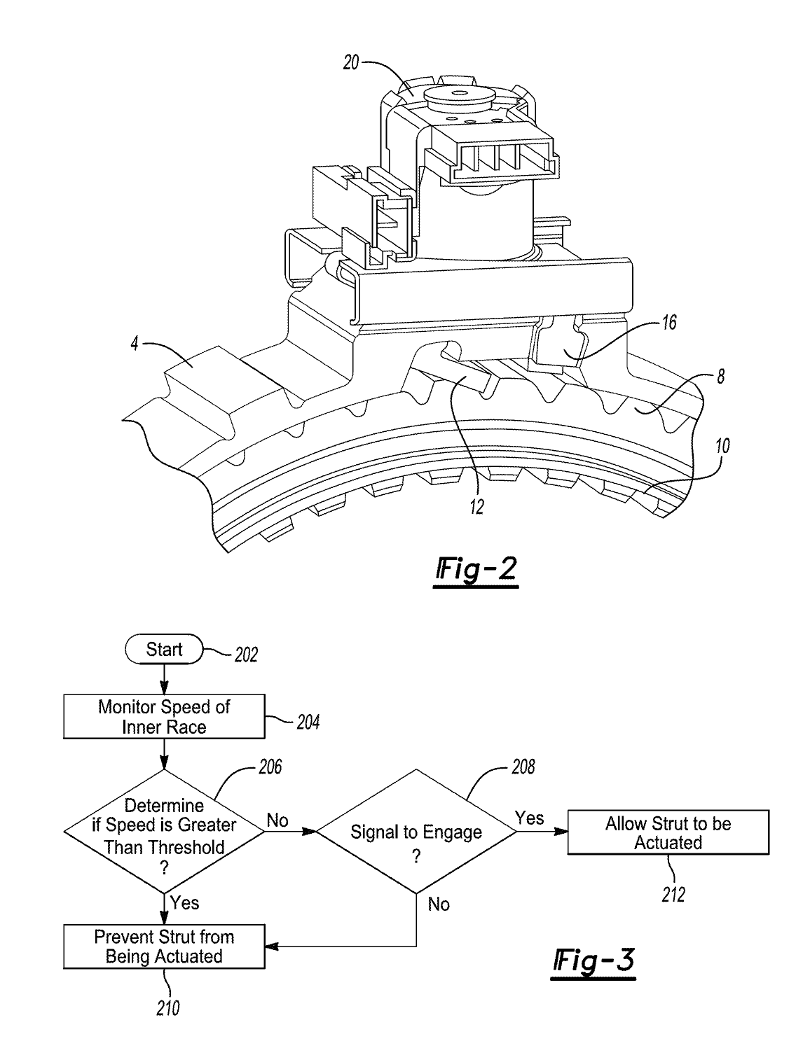

Referring to FIGS. 1 and 2, a controllable one-way clutch assembly 2 is illustrated that includes an inner race 10 and the outer race 4. The outer race is generally shaped like an annular ring. The outer race is preferably held against rotation, e.g. secured by fasteners to a fixed member or housing. With the exception of a pocket located above the axis of rotation and the few structural ribs formed within the outer race, the outer race generally has a uniform thickness. The inner surface of the outer race is generally smooth. There are two cut outs, one which is configured to house the strut 12 and another that may be configured to house a sensor 16.

The clutch 2 also includes an inner race 10 that is generally shaped as an annular ring. The inner race 10 is configured to rotate about an axis of rotation Z, and may be secured by fasteners to a rotatable shaft. A number of teeth or ridges make up the outer periphery of the inner race. The inner race may be thicker than that of the out race. In the unlocked position, the shaft connected to the inner race rotates, which in turn rotates the inner race with respect to the outer race.

The one-way clutch is shown and its locked position in FIGS. 1 and 2. A strut or a pivotable member 12 is disposed between the outer race 4 and inner race 10 and is engaged with a tooth 8 on the inner race.

The pivot axis of the strut 12 is generally parallel with the axis of rotation Z. When the strut 12 is pivoted relative to the outer race 4, the strut projects inwardly towards the axis of rotation Z.

Advantageously, the strut 12 may be formed as a single integral piece via cast aluminum or powdered metallurgy. Pockets may be formed in strut 12 at the time of initial manufacture. Thus, little additional machining is needed.

A proximity sensor 16 is disposed within the outer race 4 and is adjacent to the inner race 10. The sensor may be one of a variety of different type of sensors, e.g. photoelectric, capacitive, magnetic, and inductive among others. In the preferred embodiment, the proximity sensor is a Hall Effect sensor. The Hall Effect sensor senses a magnetic field emitted by the first race and changes to the magnetic field emitted by the tooth of the first race. The sensor detects the proximity of the tooth as the magnetic fields approach the sensor when the first race rotates.

A solenoid 20 is connected to the second race 4 and actuates the strut from a disengaged position to an engaged position and vice versa. The solenoid may be replaced by any number of electromechanical actuators that are capable of displacing a member in response to receiving an electrical current. The solenoid 20 may be of any conventional type, selected according to the requirements of a given application. The solenoid has a generally cylindrical shape and at least two openings to receive an electrical connector. In response to an electrical current, a coil within the solenoid 20 generates a magnetic field. The magnetic field drives the solenoid to exert a force on the strut 12. In such an embodiment, no bias spring is necessary to return the rocker to a starting position. In such an embodiment, the solenoid may be mechanically connected to the rocker arm, rocker elbow, or other appropriate locations.

In response to discontinuation of the electrical current, the solenoid 20 returns to the original position. The bias of a spring may then pivot the strut 12 about the pivot axis to return the strut 12 to the pocket and return the clutch to the disengaged position.

Referring to FIG. 3, a method for controlling a one-way clutch is illustrated. The method begins at 202 by rotating the first race 10 that is concentric to a second race 4. In step 204 a proximity sensor 16 detects the position of a tooth 8 of the first race 10 over time to indicate a relative speed of the first race 10 and second race 4. In step 206 the controller determines whether the speed of the first race is greater than a predetermined threshold. In step 208 a controller (not shown) receives a command to engage the first race 10 and prevents the locking of the first race in the second race in response to a speed of the first race exceeding a predetermined threshold.

A predetermined threshold may be a speed that is proportional to distance when time is held constant or inversely proportional when the distance is held constant. In yet another embodiment, the threshold may be set as a rotational speed measured in revolutions-per-minute.

As may be seen, embodiments according to the present disclosure provide a number of advantages. For example, a one-way clutch according to the present disclosure is relatively energy efficient due to the low energy usage of solenoids relative to hydraulic actuators or other known control mechanisms for one-way clutches.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A controllable one-way clutch assembly comprising:
a first annular ring having a central axis of rotation, a first periphery, and at least one tooth on the first periphery;
a second annular ring arranged concentrically with the first annular ring, and having a second periphery;
a pivotable member connected to the second annular ring and being pivotable between an engaged position wherein the pivotal member is engaged with the tooth, and a disengaged position wherein the pivotable member is disengaged from the tooth;
a sensor disposed on the second annular ring and configured to detect a presence of the at least one tooth; and
a controller programmed to prevent the pivotable member from pivoting to the engaged position in response to presence of the tooth indicating a rotational speed of the first annular ring exceeding a threshold.

2. The controllable one-way clutch of claim 1, further comprising an electromechanical actuator having a movable member configured to apply force to the pivotable member and displace the pivotable member from the disengaged position to the engaged position, wherein the controller is programmed to prevent application of force in response to the presence of the tooth indicating a rotational speed of the first annular ring exceeding a threshold.

3. The controllable one-way clutch of claim 1, wherein the sensor is configured to output a signal indicating the rotational speed of the first annular ring based on the position of the tooth.

4. The controllable one-way clutch of claim 1, wherein the sensor is a Hall Effect Sensor.

5. The controllable one-way clutch of claim 1, wherein the first annular ring emits a first magnetic field and the tooth of the first annular ring emits a second magnetic field different from the first, and wherein the sensor is configured to detect the presence of the second magnetic field as the first annular ring rotates about the central axis of rotation and the tooth is adjacent to the sensor.

6. The controllable one-way clutch of claim 1, wherein the threshold is approximately 100 revolutions per minute.

7. The controllable one-way clutch of claim 1, wherein the second annular ring has a raised section substantially perpendicular to the central axis of rotation of the first annular ring and defining a pocket therein.

8. The controllable one-way clutch of claim 7, further comprising an electromechanical actuator disposed within the pocket.

9. The controllable one-way clutch of claim 8, wherein the controller inhibits an electrical current to the electromechanical actuator in response to the presence of the tooth indicating a speed of the first annular ring exceeding a threshold.

10. The controllable one-way clutch of claim 8, wherein the controller allows electrical current to flow to the electromechanical actuator in response to the presence of the tooth indicating a speed of the first annular ring below a predetermined threshold.

11. The controllable one-way clutch of claim 8, further comprising a proximity sensor disposed within the pocket and adjacent to the first annular ring.

12. A method of controlling a one-way clutch comprising:
rotating a first race within a second race;
detecting a position of a tooth of the first race over time to indicate a relative speed of the first and second races; and
while receiving an engagement command, preventing locking of the first race and the second race in response to a speed of the first race exceeding a predetermined threshold.

13. The method of controlling a one-way clutch claim 12, wherein locking the first race includes pivoting a strut from a disengaged position to an engaged position.

14. A controllable one-way clutch comprising:
a first race having a periphery provided with a tooth;
a second race concentric to the first race;
a strut disposed between the first and second races and pivotable between an engaged position and a disengaged position;
a proximity sensor fixed to the second race and configured to detect the tooth; and
a controller to prevent engagement above a predetermined speed based on an output from the proximity sensor.

15. The controllable one-way clutch of claim 14, wherein the controller is an electrical circuit that is disposed on either the first or second race.

16. The controllable one-way clutch of claim 14, wherein the second race partially surrounds the first race.

17. The controllable one-way clutch of claim 14, wherein the first race emits a first magnetic field and the tooth of the first race emits a second magnetic field different from the first, and wherein the proximity sensor detects the proximity of the tooth as the first and second magnetic fields approach the sensor as the first race rotates.

18. The controllable one-way clutch of claim 14, wherein the proximity sensor is a Hall Effect Sensor.

19. The controllable one-way clutch of claim 14, wherein the strut in an engaged position is engaged with the tooth of the first race and in the disengaged position the strut is not engaged with the tooth of the first race.

20. The controllable one-way clutch of claim 14, wherein the engaged position locks the first and the second races together.
